(19) United States
(12) Patent Application Publication
(10) Pub. No.: US 2026/0177169 A1
(43) Pub. Date: Jun. 25, 2026

(54) Method and Apparatus for Increasing the Collapse Resistance of a Flexible Pipe

(71) Applicant: Polyflow LLC, Midland, TX (US)

(72) Inventor: Devon Cameron VEHLOW, Newcastle upon Tyne (GB)

(73) Assignee: Polyflow LLC, Midland, TX (US)

(21) Appl. No.: 18/986,950

(22) Filed: Dec. 19, 2024

(51) Int. Cl. F16L 11/10; E21B 17/20

(52) U.S. Cl. CPC F16L 11/10; E21B 17/20

(57) ABSTRACT

There is provided a method of increasing the collapse resistance of a region of a flexible pipe. The method includes providing a flexible pipe body having a plurality of pipe layers and deploying a reinforcement insert into a bore of the flexible pipe body through a free end thereof. A clamping force is applied to an external surface of the flexible pipe body at a location corresponding to the reinforcement insert. The reinforcement insert opposes radially inwards collapse of at least one layer of the flexible pipe body as a result of the clamping force. After removing the clamping force, the method includes either leaving the reinforcement insert within the bore of the flexible pipe body; or disassembling or mechanically retracting the reinforcement insert and retrieving it through the free end of the flexible pipe body.

### TECHNICAL FIELD

This invention relates generally to a method of increasing the collapse resistance of a region of a flexible pipe, e.g. a flexible pipe for conveying fluid relating to oil and gas operations. The invention also invention relates to a reinforcement insert for increasing the collapse resistance of a region of a flexible pipe.

### BACKGROUND

Unbonded reinforced thermoplastic pipe (RTP) is a flexible, high-performance pipe typically used in oil and gas applications for transporting fluids, including hydrocarbons, water, and gas. Sometimes these may referred to as flexible pipes. Unlike traditional rigid pipelines, RTP comprises multiple layers, each serving a distinct purpose: an inner layer provides fluid containment; a reinforcement layer surrounds the inner layer and resists mechanical loads, including tensile loads and internal pressure; and an outer layer surrounds the reinforcement layer and protects the pipe from external damage and environmental factors. The term “unbonded” refers to the fact that the layers of the pipe are not adhesively, or otherwise, bonded to one another.

RTP systems are sometimes used in production tubing or velocity strings to convey hydrocarbons from a well (e.g. an oil well) to a wellhead. To ensure the safe and reliable operation of an RTP system, sections of pipe are joined using end fittings. An end fitting serves as the transition point between adjacent sections of RTP, as well between a section of pipe and other parts of the pipeline or equipment.

During installation of such an RTP system, at certain times one or more regions of a RTP is supported temporarily at a desired position to allow for the installation of an end fitting. In the absence of the end fitting, an external clamp is used to apply a clamping force to an external surface of the RTP body and may support the weight of the full length of RTP in the well.

In order for an installation to be successful, the pull force provided by the external clamp must equal the RTP weight and retractive force. The retractive force may be the force required to release/break packers and overcome friction with other tubing. However, the weight of RTP that can be supported by the clamp increases with the clamping force. Simply increasing the clamping force does not solve the issue because RTP can have low radial strength and stiffness. High clamping force will thus result in deforming and even crushing RTP body. The pipe is prone to partial or complete collapse under clamping pressure.

It is therefore an object of embodiments of the invention to provide a method of increasing the collapse resistance of a flexible pipe and an apparatus for facilitating the same that overcomes, or at least mitigates, one or more problems associated with known arrangements.

### SUMMARY OF THE INVENTION

According to an aspect of the invention, there is provided a method of increasing the collapse resistance of a region of a flexible pipe, the method comprising: providing a flexible pipe body having a plurality of pipe layers; deploying a reinforcement insert into a bore of the flexible pipe body through a free end thereof; applying a clamping force to an external surface of the flexible pipe body at a location corresponding to the reinforcement insert such that the reinforcement insert opposes radially inwards collapse of at least one layer of the flexible pipe body as a result of the clamping force; and after removing the clamping force, either leaving the reinforcement insert within the bore of the flexible pipe body; or disassembling or mechanically retracting the reinforcement insert and retrieving it through the free end of the flexible pipe body.

In some embodiments, the method comprises providing a clamping force via clamping elements sufficient to support the weight of the flexible pipe via the clamping elements.

In some embodiments, the method comprises: prior to leaving the reinforcement insert within the bore or disassembling or mechanically retracting the reinforcement insert, securing an end fitting to the free end of the flexible pipe body, wherein the end fitting reduces the bore of the flexible pipe at the free end.

In some embodiments, the method comprises permanently securing the reinforcement insert within the bore of the flexible pipe body prior to applying the clamping force to an external surface of the flexible pipe body.

In some embodiments, the method comprises permanently securing the reinforcement insert within the bore of the flexible pipe body during manufacture of the flexible pipe body. In some embodiments, the method comprises permanently securing the reinforcement insert within the bore of the flexible pipe body prior after removing the clamping force.

In some embodiments, the method comprises deploying the reinforcement insert in an interference fit or a friction fit with the radially inner surface of the flexible pipe body.

In some embodiments, the method comprises first lubricating the internal bore of the flexible pipe body prior to deploying the reinforcement insert.

In some embodiments, permanently securing the reinforcement insert comprises securing a collar to an external surface of the flexible pipe body at a location corresponding to the reinforcement insert.

The method may comprise compressing a portion of the flexible pipe body between the reinforcement insert and the collar.

In some embodiments, permanently securing the reinforcement insert comprises heating the flexible pipe body at the location corresponding to the reinforcement insert.

In some embodiments, deploying the reinforcement insert comprises: providing the reinforcement insert in a retracted condition when inserting it into the free end of the flexible pipe and positioning it at a location along the length of the flexible pipe body; and once the reinforcement insert is positioned at the desired location, configure or reconfigure the reinforcement insert into a deployed condition by actuating the reinforcement insert so as to radially displace one or more bracing members towards the radially inner surface of the flexible pipe body.

In some embodiments, deploying the reinforcement insert comprises providing the reinforcement insert on a running or workover tool.

In some embodiments, moving or configuring the reinforcement insert into the deployed condition, e.g. from the retracted condition, comprises actuating the reinforcement insert to thereby increase an outer diameter thereof.

In some embodiments, moving or configuring the reinforcement insert into the deployed condition, e.g. from the retracted condition, comprises actuating the reinforcement insert to thereby increase at least one external dimension thereof.

In some embodiments, moving or configuring the reinforcement insert into the deployed condition, e.g. from the retracted condition, comprises activating an actuation mechanism or actuator of the reinforcement insert to radially displace the one or more bracing members.

The actuation mechanism or actuator may comprise a screw actuator or a linear actuator, e.g. a hydraulic or electric actuator.

In some embodiments, moving or configuring the reinforcement insert into the deployed condition, e.g. from the retracted condition, comprises displacing the one or more bracing members into contact with the radially inner surface of the flexible pipe body.

In some embodiments, moving or configuring the reinforcement insert into the deployed condition comprises displacing a drive member, e.g. an axial drive member, having one or more abutment surfaces into contact with a respective abutment of each bracing member to thereby displace the bracing member(s) towards the radially inner surface of the flexible pipe body.

In some embodiments, the method comprises axially displacing the axial drive member, e.g. upon activation of the actuator.

In some embodiments, the method comprises displacing the drive member, e.g. axial drive member, towards the one or more bracing members.

In some embodiments, moving or configuring the reinforcement insert into the deployed condition comprises displacing a pair of opposed axial drive members each having one or more abutment surfaces towards one another and into contact with a corresponding respective abutment surface of each bracing member to thereby displace the bracing member(s) radially outwards.

In some embodiments, the method comprises: wherein subsequent to configuring the reinforcement insert into the deployed condition, retrieving the reinforcement insert, wherein retrieving the reinforcement insert comprises configuring the reinforcement insert into the retracted condition by actuating the reinforcement insert so as to radially displace one or more bracing members away from the radially inner surface of the flexible pipe body.

In some embodiments, moving or configuring the reinforcement insert into the retracted condition, e.g. from the deployed condition, comprises actuating the reinforcement insert to thereby decrease an outer diameter thereof.

In some embodiments, moving or configuring the reinforcement insert into the retracted condition, e.g. from the deployed condition, comprises actuating the reinforcement insert to thereby decrease at least one external dimension thereof.

In some embodiments, moving or configuring the reinforcement insert into the retracted condition, e.g. from the deployed condition, comprises displacing the one or more bracing members out of contact with the radially inner surface of the flexible pipe body.

In the retracted condition the outer diameter of the reinforcement insert may be less than an inner diameter of an end fitting secured to the free end of the flexible pipe body.

In some embodiments, moving the reinforcement insert into the retracted condition comprises mechanically retracting the reinforcement insert.

In some embodiments, moving or configuring the reinforcement insert into the retracted condition comprises displacing a drive member, e.g. axial drive member, having one or more abutment surfaces out of contact with a respective abutment of each bracing member to thereby displace the bracing member(s) away from the radially inner surface of the flexible pipe body.

In some embodiments, the method comprises displacing the axial drive member away from the one or more bracing members.

In some embodiments, in the retracted condition the reinforcement insert has a first outer diameter and in the deployed condition the reinforcement insert has a second outer diameter, wherein the second outer diameter is greater than the first outer diameter.

In some embodiments, deploying the reinforcement insert comprises: positioning a first reinforcement insert portion at a location along the length of the flexible pipe body; positioning at least one further reinforcement insert portion at a location along the length of the flexible pipe body; and engaging the first and at least one further reinforcement insert portion(s) such that they together oppose radially inwards collapse of at least one layer of the flexible pipe body due to the clamping force.

In some embodiments, engaging the first and at least one further reinforcement insert portion(s) comprises inserting a male segment of one of the portions into a female segment of another of the portions.

In some embodiments, each of the first and at least one further reinforcement insert portion(s) comprise a part-cylindrical outer bracing surface.

In some embodiments, retrieving the reinforcement insert comprises: disengaging the first and at least one further reinforcement insert portion(s) so as to disassemble the reinforcement insert; retrieving one of the first and at least one further reinforcement insert portion(s) from the bore of the flexible pipe body; subsequently retrieving the other insert portion(s) from the bore of the flexible pipe body.

In some embodiments, deploying the reinforcement insert comprises positioning the reinforcement insert a distance of between 1 metre and 40 metres from the free end of the flexible pipe body, for example, between 10 metres and 40 metres, between 10 metres and 30 metres, between 20 metres and 40 metres or between 20 metres and 30 metres.

In some embodiments, the flexible pipe body comprises a segment, e.g. an end segment, of a tubing string, a production string or a velocity string. The string may extend into a well e.g. an oil, gas and/or geothermal well.

According to another aspect of the invention there is provided a reinforcement insert for increasing the collapse resistance of a region of a flexible pipe, the reinforcement insert comprising: one or more radially displaceable bracing members configured to be displaced toward a radially inner surface of a flexible pipe body, in use; an actuation mechanism arranged to configure the reinforcement insert between a retracted condition and a deployed condition by radial displacement of the bracing member(s); wherein when configuring the reinforcement insert from the retracted condition to the deployed condition the one or more bracing members are displaced radially outwards so as to increase at least one external dimension of the reinforcement insert.

In some embodiments, in the retracted condition the reinforcement insert has a first outer diameter and in the deployed condition the reinforcement insert has a second outer diameter, wherein the second outer diameter is greater than the first outer diameter.

In some embodiments, the reinforcement insert comprises: a drive member, e.g. axial drive member, having one or more abutment surfaces configured to contact a corresponding respective abutment surface of each bracing member.

In some embodiments, the actuator mechanism is arranged to configure the reinforcement insert from the retracted condition to the deployed condition by displacing the axial drive member towards the bracing member(s) to bring the abutment surfaces into contact and thereby displace the bracing member(s) radially outwards.

In some embodiments, the actuator mechanism comprises a screw actuator.

In some embodiments, the reinforcement insert comprises two, three, four, five or six bracing members. The bracing members may be equally spaced, e.g. angularly spaced, around a longitudinal or central axis of the reinforcement insert.

In some embodiments, each bracing member comprises a part cylindrical outer surface.

In some embodiments, the part cylindrical outer surface is a bracing surface.

In some embodiments, the reinforcement insert comprises a connector for releasable connection to a running tool.

In some embodiments, the reinforcement comprises: a pair of opposed axial drive members each having one or more abutment surfaces configured to contact a corresponding respective abutment surface of each bracing member.

In some embodiments, the actuator mechanism is arranged to configure the reinforcement insert from the retracted condition to the deployed condition by displacing the axial drive members towards one another to bring the abutment surface(s) of the axial drive members into contact with the abutment surface(s) of the bracing member(s) and thereby displace the bracing member(s) radially outwards.

In some embodiments, the abutment surfaces each comprise a chamfer.

According to another aspect of the invention there is provided a reinforcement insert for increasing the collapse resistance of a region of a flexible pipe, the reinforcement insert comprising: a first reinforcement insert portion for positioning at a location along a length of flexible pipe body; at least one further reinforcement insert portion for positioning at a location along a length of flexible pipe body, wherein each of the first and at least one further reinforcement insert portion are configured to engage one another such that they together oppose radially inwards collapse of at least one layer of the flexible pipe body due to the clamping force, in use.

In some embodiments, each of the reinforcement insert portions comprise a part cylindrical outer surface.

In some embodiments, the part cylindrical outer surface is a bracing surface.

In some embodiments, the first reinforcement insert portion comprises one of a male or female segment and at least one further reinforcement portion comprises the other of a male or female segment.

In some embodiments, the reinforcement insert comprises a first reinforcement insert portion and a second reinforcement insert portion. Each of the first and second reinforcement insert portions may comprise a half-cylindrical or semi-cylindrical outer surface.

In some embodiments, the first reinforcement insert portion comprises one of a male or female segment and the second reinforcement portion comprises the other of a male or female segment.

In some embodiments, the reinforcement insert comprises two, three, four, five or six reinforcement insert portions. The reinforcement insert portions may be equally spaced, e.g. angularly spaced, around a longitudinal or central axis of the reinforcement insert.

The first reinforcement insert portion may be configured to engage the second reinforcement insert portion to form or define a cylindrical outer surface.

The plurality of reinforcement insert portions may be configured to engage one another to form or define a cylindrical outer surface.

For the avoidance of doubt, any of the features described herein apply equally to any aspect of the invention. For example, the reinforcement insert may comprise any one or more features or steps of the method relevant to the reinforcement insert and/or the method may comprise any one or more features or steps relevant to one or more features of the reinforcement insert.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a section view of a flexible pipe body;

FIG. 2 is a cross-sectional view of the flexible pipe body of FIG. 1;

FIG. 3 is a free body diagram of a flexible pipe body of FIG. 1 when supported by an external clamp;

FIG. 4 is a cross-sectional view of a reinforcement insert according to an embodiment;

FIG. 5 is a cross-sectional view of a reinforcement insert in a retracted condition according to an embodiment;

FIG. 6 is a cross-sectional view of the reinforcement insert of FIG. 5 in a deployed condition; and

FIG. 7 is a perspective view of a reinforcement insert according to an embodiment.

### DETAILED DESCRIPTION

Generally, embodiments of the invention have application in oil and gas operations, e.g., for transporting oil and gas field fluids, and/or mining operations, e.g., for transporting abrasive slurries, including tailings, mineral-rich slurries, and other harsh fluids. Other applications are contemplated, including water management, municipal utilities, and chemical processing. Moreover, embodiments of the invention may have particular application as RTP, including unbonded RTP, the properties of which—in particular flexibility, durability, and the ability to handle high pressures—make it an attractive option in various industrial applications. Unlike steel pipes, RTP does not corrode, making it ideal for transporting aggressive chemicals, saline water, and other corrosive substances.

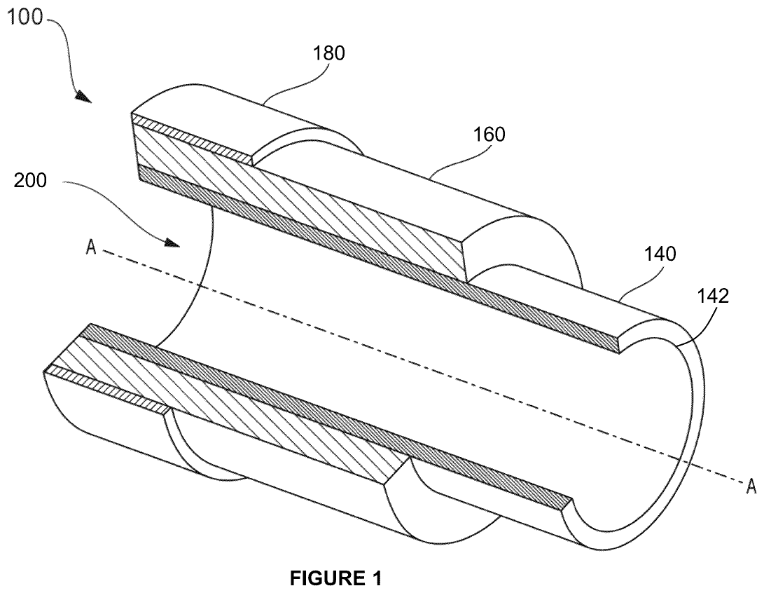

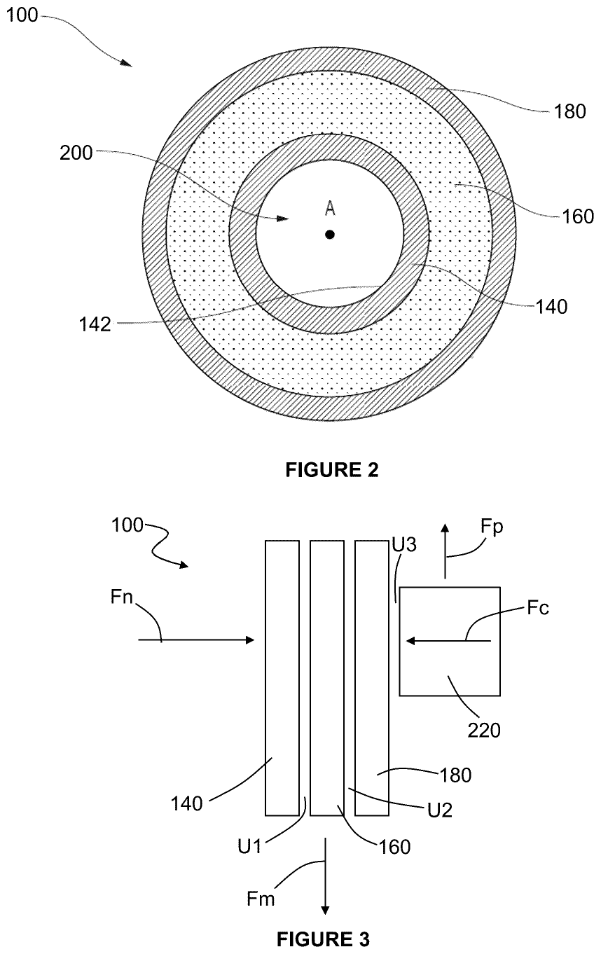

Referring now to FIGS. 1 and 2, there is shown an example flexible pipe body 100, which is an RTP body in this embodiment. The flexible pipe body 100 has a first pipe layer 140, a second pipe layer 160 and a third pipe layer 180. The second pipe layer 160 is disposed intermediate the first and third pipe layers 140, 180. As such, the third pipe layer 180 is located radially outward of the second pipe layer 160 and the first pipe layer 140 is located radially inward of the second pipe layer 160.

As in the illustrated embodiment, the second pipe layer 160 may be in direct contact with the first pipe layer 140 and/or the third pipe layer 180. Alternatively, further pipe layers may be provided intermediate the first pipe layer 140 and the second pipe layer 160 and/or the third pipe layer 180. The flexible pipe body 100 delimits a central bore 200 extending along a longitudinal axis A-A. The central bore 200 is arranged to convey a fluid, e.g., a hydrocarbon fluid, along the length of the flexible pipe body 100.

The first pipe layer 140 is a fluid retaining layer which is non-porous. In certain embodiments, the first pipe layer 140 is tubular in shape. The first pipe layer 140 is a polymer layer that ensures internal fluid containment. The layer can provide a boundary for any conveyed fluid. It is to be understood that the first pipe layer 140 may itself comprise a number of sub-layers in some embodiments.

The first pipe layer 140 is made of high-density polyethylene (HDPE) in the present embodiment. It will be appreciated that in other embodiments, the first pipe layer 140 may be made of a different polymer. It will be appreciated that in some embodiments, the first pipe layer 140 may consist of any polyethylene, polyethylene raised temperature, polypropylene, a polyamide, or polyvinylidene difluoride (PVDF). The first pipe layer 140 in FIGS. 1 and 2 is formed by an extrusion process, although it will be appreciated by a person skilled in the art that the fluid retaining layer may be manufactured in other ways.

The first pipe layer 140 is the innermost layer of the flexible pipe body 100 and has a radially inner surface 142 that defines the central bore 200. In certain embodiments, the internal diameter of the fluid retaining layer—which may also be referred to as the bore—may be between 2 inches (50.8 mm) and 6 inches (152.4 mm), but preferably within the range of 3 inches (76.2 mm) and 4 inches (101.6 mm). It will be appreciated that in other embodiments the central bore 200 may be larger or smaller in diameter. In certain embodiments, the bore fluid is constrained to being within the central bore 200 of the flexible pipe body 100.

The second pipe layer 160 is a thermoplastic reinforcement layer. The thermoplastic reinforcement layer may also be referred to as a reinforcement layer. The second pipe layer 160 provides structural support to the flexible pipe body 100. In other words the second pipe layer 160 may help to improve the resistance of the flexible pipe body 100 to internal or external pressures, axial tensile forces, torsion, or the like. The second pipe layer 160 is coaxial and radially external to the first pipe layer 140. As shown in FIGS. 1 and 2, the second pipe layer 160 is in physical contact with the first pipe layer 140. It will be appreciated that in some embodiments, the second pipe layer 160 may be composed of a plurality of layers.

The second pipe layer 160 is formed of one or more pairs of tapes cross-wound around the first pipe layer 140 with a lay angle of around +/−55°(not shown). In other words, each pair of tapes is wound helically in clockwise and counter clockwise directions respectively. It will be appreciated that, in other embodiments, the lay angle may be between 0°and 90°. In certain embodiments the pairs of tapes may be wound in regularly-separated hoops of a given radius. In certain embodiments the pairs of tapes may not be wound at all. It will be appreciated that the lay angle may be chosen depending on the reinforcement requirements of the second pipe layer 160. For example, a shallower lay angle may provide greater resistance to axial forces along the flexible pipe body 100. The reinforcement tapes may be made of glass fibre/polymer matrix, carbon fibre/polymer matrix, aramid fibre/polymer matrix, steel fibre/polymer matrix, or the like. The reinforcement may be formed of a plurality of metallic wires, or strands, e.g., steel wires or wires formed of a metal alloy. However, the reinforcement may be provided by any suitable material, including aramid fibre, glass fibre, basalt fibre, and carbon fibre.

It will be appreciated that in other embodiments, the steel fibre may be exchanged for an alternative electrically conductive metal, polymer, carbon, ceramic, or the like, or a mixture of electrically conductive fibres and non-conductive reinforcement fibres where the electrically conductive fibres provide little or no structural reinforcement to the flexible pipe body 100 and purely act to facilitate consolidation of pipe layers. It will be appreciated that the steel fibre may itself be composed of multiple fibres threaded or otherwise bunched together.

It will be appreciated that the polymer matrix material may be formed from any suitable thermoplastic polymer or polymer compound. Suitable polymers include polyvinylidene fluoride (PVDF), polyethylene (PE) including grades of raised polyethylene of temperature resistance (PE-RT) and cross-linked polyethylene (PEX), polyphenylene sulphide (PPS), polypropylene (PP), a thermoplastic elastomer, and a polyamide. These thermoplastics are commonly used in the manufacture of RTP.

It will also be appreciated that in some embodiments, the second pipe layer 160 may comprise conductive fibres or strands or bunches of fibres which may be applied to the pipe without being incorporated into a tape (i.e. without a polymer matrix around the fibres).

The third pipe layer 180 is an outer sheath, which comprises a polymer layer used to protect the flexible pipe body 100 against penetration of seawater and other external environments, corrosion, abrasion and mechanical damage. The third pipe layer 180 is coaxial to the first pipe layer 140 and the second pipe layer 160. As shown in FIGS. 1 and 2, the third pipe layer 180 is in physical contact with the second pipe layer 160. The third pipe layer 180 is the outermost layer of the flexible pipe body 100.

The third pipe layer 180 is made of HDPE and is manufactured using an extrusion process. It will be appreciated that in other embodiments, the third pipe layer 180 may consist of any polyethylene, a polypropylene, or a polyamide. It will be appreciated that in other embodiments, a manufacturing process such as extrusion, tape winding or the like may be used to make the outer sheath.

The central bore 200 of the flexible pipe body 100 is hollow. Bore fluid, e.g. from a well, is able to flow in a direction broadly parallel with the central axis A-A of the flexible pipe body 100.

In the present embodiment, a length of flexible pipe extending into a well includes a plurality of flexible pipe segments or sections of flexible pipe body 100. The flexible pipe segments together may define a production string or a velocity string and each segment or section (hereinafter “segment”) of the flexible pipe may have body 100 may have the structure described above.

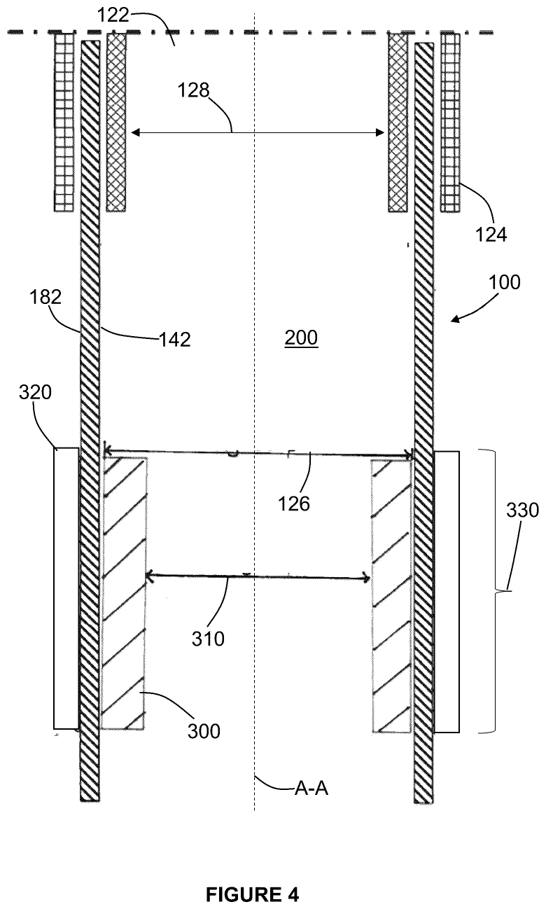

The segments of flexible pipe body 100 are connected together with a splice coupling (or end fitting), e.g. as shown by reference numeral 124 in FIG. 4, located at least one end of the flexible pipe body 100. The splice coupling is a mechanical device which may form the transition between segments of flexible pipe body 100 and a connector. The different pipe layers as shown, for example, in FIGS. 1 and 2 are terminated in the splice coupling in such a way as to transfer the load between flexible pipe body 100 and the connector.

During installation, when a length of flexible pipe is fully deployed in a well it is necessary to attach an end fitting to a free end of flexible pipe body 100 located at the surface to allow for connection of a further segment of flexible pipe body 100, e.g. deployed from a reel, or to allow for connection to a wellhead. Until the end fitting is attached, a region of the flexible pipe body 100 must be temporarily supported. Due to the absence of an end fitting an external clamp is used to apply a clamping force to an external surface of the flexible pipe body 100 such that the weight of the full length of flexible pipe in the well is supported.

Referring now to FIG. 3, there is shown a free body diagram of a portion of flexible pipe body 100 being supported by an external clamp 220. There are a number of friction values that describe the interaction between the layers of the flexible pipe body 100. U1 describes the friction coefficient between the first pipe layer 140 and the second pipe layer 160, U2 describes the friction coefficient between the second pipe layer 160 and the third pipe layer 180 and U3 is the friction coefficient between the third pipe layer 180 and an external clamp 220.

In the absence of an end fitting, the external clamp 220 grips the flexible pipe body 100 with a clamp force Fc. The clamp force Fc is reacted against by a liner normal force Fn provided by the first pipe layer 140. Fn is a function of the collapse strength of the first pipe layer 140.

To react against the pipe weight Fm, a pull force Fp is applied by the clamp 220. In order to prevent tearing of the flexible pipe body 100, the pull force Fp cannot exceed the available maximum frictional load between the layers 140, 160, 180. In order for an installation to be successful, the pull force Fp provided by the clamp 220 must equal the pipe weight Fm. Therefore, an increase in pipe weight Fm must be matched by an increase in pull force Fp.

The pull force Fp can be viewed as the total equivalent coefficient of friction between the pipe layers 140, 160, 180 multiplied by the normal force Fn. Therefore, an increase in pull force Fp can be achieved by an increase in normal force Fn.

As the available normal force Fn is limited by the design of the first pipe layer 140 it is necessary to provide reinforcement to the flexible pipe body 100 to allow for an increase in normal force Fn.

Referring now to FIG. 4, there is shown a permanently installed reinforcement insert 300 received within a segment of flexible pipe body 100. Although not shown in FIG. 4, it will be appreciated that the flexible pipe body 100 will include layers as described above in respect of FIGS. 1 and 2. The flexible pipe body 100 has a free end 122 having an end fitting 124 attached thereto. The flexible pipe body 100 has a central bore 200 having an internal diameter 126. The end fitting 124 defines an internal diameter 128 that is less than the internal diameter 126 of the bore 200.

The reinforcement insert 300 is deployed into the free end 122 of the flexible pipe body 100 prior to the end fitting 124 being attached. It will be appreciated that the reinforcement insert 300 may be permanently secured within the flexible pipe body 100 prior to the end fitting 124 being attached. In some cases, the reinforcement insert 300 may be secured within the flexible pipe body 100 during manufacture.

The reinforcement insert 300 is a permanent insert in this embodiment and is provided in interference fit with the radially inner surface 142 of the flexible pipe body 100. The reinforcement insert 300 is an annular body and extends along a portion of the longitudinal axis A-A of the flexible pipe body 120. The annular body provides a bore having an internal diameter 310, less than the internal diameter 126 of the central bore 200, to allow for the passage of fluid along central bore 200. The reinforcement insert 300 opposes radially inwards collapse of at least one layer of the flexible pipe body 100 as a result of a clamping force provided within clamping region 330, corresponding to the location of the reinforcement insert 300. The reinforcement insert 300 allows for sufficient clamping force to be applied to the flexible pipe body 100 to support the weight of flexible pipe whilst the end fitting 124 is attached.

After the end fitting 124 is attached, due to the decreased diameter 128 it is not possible to remove the reinforcement insert 300. Therefore, the reinforcement insert 300 is permanently secured within in the flexible pipe body 100 via a collar 320. The collar 320 is secured to an external surface 182 of the flexible pipe body 100 at a location corresponding to the reinforcement insert 300 and compresses a portion of the flexible pipe body 100 between the reinforcement insert 300 and the collar 320.

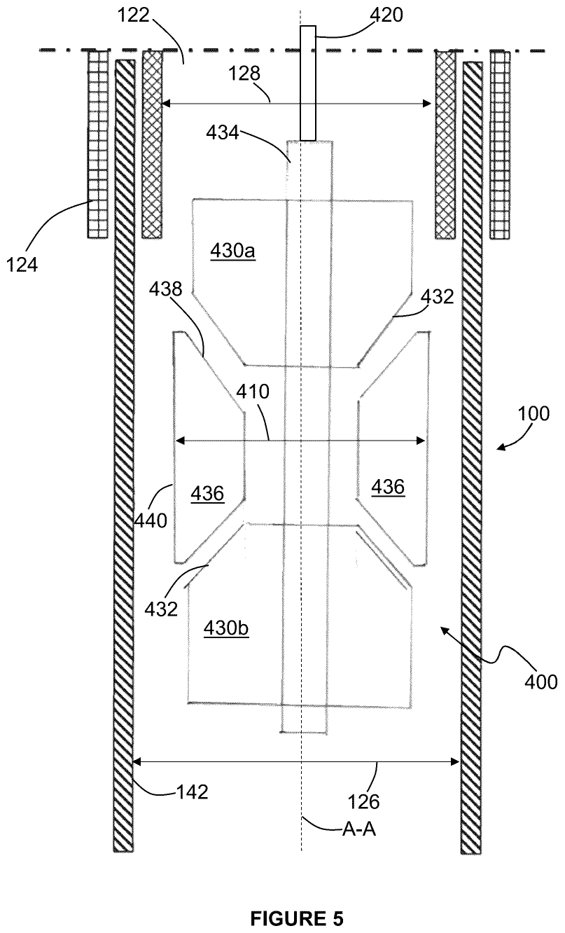

Referring now to FIG. 5, there is shown a removeable reinforcement insert 400 received within a segment of flexible pipe body 100. The flexible pipe body 100 is as described above in relation to FIG. 4, and like references denote like features.

The reinforcement insert 400 is shown in a retracted condition in FIG. 5, and has an outer diameter 410 less than each of the internal diameter 126 of the central bore and the internal diameter 128 of the end fitting 124. The reinforcement insert 400 is deployed on a running tool 420 into the free end 122 of the flexible pipe body 100 prior to the end fitting 124 being attached.

The reinforcement insert 400 has a pair of opposed axial drive members 430a, 430b each having respective chamfered abutment surfaces 432. The drive members 430a, 430b are axially displaceable towards one another by an actuator 434, which is a linear actuator in this embodiment. The chamfered abutment surfaces 432 of the drive members 430a, 430b are configured to contact a pair of bracing members 436, and more specifically chamfered abutment surfaces 438 thereof. The bracing members 436 each have a respective bracing surface 440 configured to contact the radially inner surface 142 of the flexible pipe body 100 when the reinforcement insert 400 is in a deployed condition, as discussed in greater detail below.

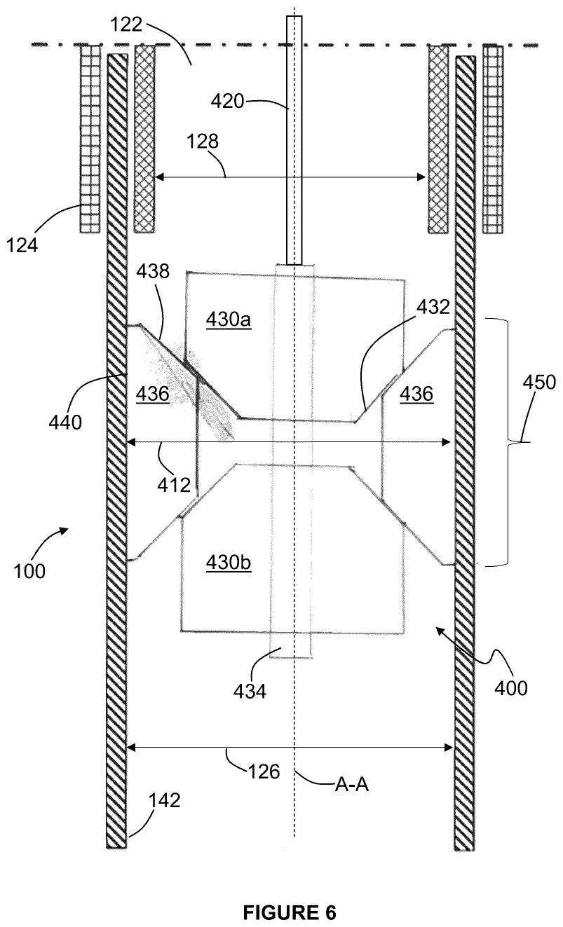

Referring now to FIG. 6, when the reinforcement insert 400 is positioned at a desired location within the flexible pipe body 100, it is configured into a deployed condition. In order to configure the reinforcement insert 400 into the deployed condition, the actuator 434 is activated so as do displace the axial drive members 430a, 430b towards one another. The chamfered abutment surfaces 432 of the axial drive members 430a, 430b come into contact with the chamfered abutment surfaces 438 of the bracing members 436 and radially displace the bracing members 436 towards, and into contact with, the radially inner surface 142 of the flexible pipe body 100. It will be appreciated that the bracing members 436 need not contact the radially inner surface 142 of the flexible pipe body 100, but instead may be positioned adjacent thereto.

When in the deployed condition the outer diameter 412 of the reinforcement insert 400 is greater than the outer diameter 410 in the retracted condition.

When in the deployed condition, the reinforcement insert 400 opposes radially inwards collapse of at least one layer of the flexible pipe body 100 as a result of a clamping force provided within clamping region 450, corresponding to the location of the deployed reinforcement insert 400. The reinforcement insert 400 allows for sufficient clamping force to be applied to the flexible pipe body 100 to support the weight of flexible pipe whilst the end fitting 124 is being attached.

After the end fitting 124 is attached, the reinforcement insert 400 can be retrieved by configuring it into the retracted condition. The actuator 434 is activated so as to displace the axial drive members 430a, 430b away from one another, and thereby displace the bracing members 436 away from the radially inner surface 142 of the flexible pipe body 100. As stated above, in the retracted condition the reinforcement insert 400 has an outer diameter 410 less than each of the internal diameter 126 of the central bore and the internal diameter 128 of the end fitting 124. As such, the reinforcement insert 400 can be retrieved through or past the end fitting 124.

It will be appreciated that the reinforcement insert 400 need not include two bracing members 436 as described, but instead may include any suitable number of bracing members 436.

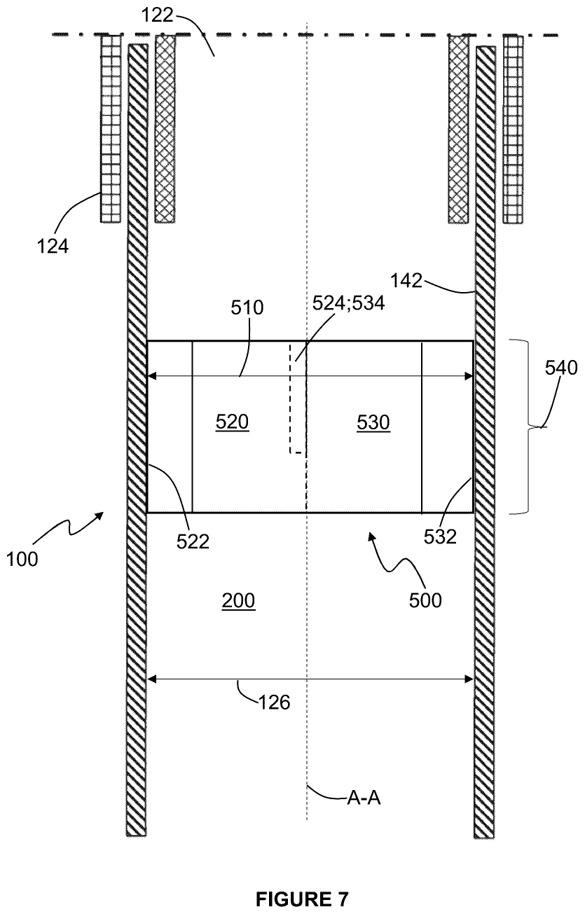

Referring now to FIG. 7, there is shown a removeable reinforcement insert 500 received within a segment of flexible pipe body 100. The flexible pipe body 100 is as described above in relation to FIG. 4, and like references denote like features.

The reinforcement insert 500 is shown in an assembled condition in FIG. 7, and has an outer diameter 510 approximately equal to the internal diameter 126 of the central bore 200. Although not shown, in practice the reinforcement insert 500 would be deployed on one or more running tools into the free end 122 of the flexible pipe body 100 prior to the end fitting 124 being attached.

The reinforcement insert 500 includes a first reinforcement insert portion 520 and a second reinforcement insert portion 530. Each of the portions 520, 530 has a respective semi-cylindrical outer bracing surface 522, 532 configured to contact the radially inner surface 142 of the flexible pipe body 100 when the reinforcement insert is assembled.

In the present embodiment, the first reinforcement insert portion 520 has a female segment, in the form of a slot 524, and the second reinforcement insert portion 530 has a male segment, in the form of an elongate protrusion 534.

The reinforcement insert 500 is deployed by positioning the first reinforcement insert portion 520 at a location along the flexible pipe body 100. The second reinforcement insert portion 530 is then positioned at a location along the flexible pipe body 100 and reinforcement insert 500 is assembled by engaging the elongate protrusion 534 with the slot 524. When assembled, the first and second reinforcement insert portions 520, 530 define a cylindrical outer bracing surface that opposes radially inwards collapse of at least one layer of the flexible pipe body 100 due to a clamping force applied within clamping region 540. As with the reinforcement inserts described above, the reinforcement insert 500 allows for sufficient clamping force to be applied to the flexible pipe body 100 to support the weight of flexible pipe whilst the end fitting 124 is being attached.

After the end fitting 124 is attached, the reinforcement insert 500 can be retrieved by disengaging the first and second reinforcement insert portions 520, 530 so as to disassemble the reinforcement insert 500. One of the first second reinforcement insert portions 520, 530 is retrieved from the central bore 200 of the flexible pipe body 100 and subsequently the other insert portion is retrieved from the central bore of the flexible pipe body 100.

Although the reinforcement insert 500 is shown having two reinforcement insert portions, this need not be the case. Instead, there may be three, four, five or any other suitable number of reinforcement insert portions. Each reinforcement insert portion 520, 530 is such that it can be removed through the internal diameter 128 of the end fitting 124.

It will be appreciated that the method described herein for fitting a reinforcement insert within a segment of flexible pipe may also be used to deploy a permanently installed reinforcement insert inside a segment of flexible pipe body. For example the reinforcement insert 400 may also be used to transport a reinforcement insert 300 to the position where it will be permanently installed, and the mechanism used for temporary installation of the reinforcement insert 400 may be used to permanently deform the reinforcement insert 300 radially outwards to secure it in the intended position and so provide a permanently installed reinforcement insert.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1. A method of increasing the collapse resistance of a region of a flexible pipe, the method comprising:
providing a flexible pipe body having a plurality of pipe layers;
deploying a reinforcement insert into a bore of the flexible pipe body through a free end thereof;
applying a clamping force to an external surface of the flexible pipe body at a location corresponding to the reinforcement insert such that the reinforcement insert opposes radially inwards collapse of at least one layer of the flexible pipe body as a result of the clamping force; and
after removing the clamping force, either
leaving the reinforcement insert within the bore of the flexible pipe body; or
disassembling or mechanically retracting the reinforcement insert and
retrieving it through the free end of the flexible pipe body.

2. The method as claimed in claim 1, further comprising:
providing a clamping force via clamping elements sufficient to support the weight of the flexible pipe via the clamping elements; and
prior to leaving the reinforcement insert within the bore or disassembling or mechanically retracting the reinforcement insert, securing an end fitting to the free end of the flexible pipe body, wherein the end fitting reduces the bore of the flexible pipe at the free end.

3. The method as claimed in claim 1, further comprising:
permanently securing the reinforcement insert within the bore of the flexible pipe body prior to applying the clamping force to an external surface of the flexible pipe body.

4. The method as claimed in claim 1, further comprising:
deploying the reinforcement insert in an interference fit with the radially inner surface of the flexible pipe body.

5. The method as claimed in claim 4, further comprising:
first lubricating the internal bore of the flexible pipe body prior to deploying the reinforcement insert.

6. The method as claimed in claim 1, wherein permanently securing the reinforcement insert comprises securing a collar to an external surface of the flexible pipe body at a location corresponding to the reinforcement insert and compressing a portion of the flexible pipe body between the reinforcement insert and the collar.

7. The method as claimed in claim 1, wherein permanently securing the reinforcement insert comprises heating the flexible pipe body at the location corresponding to the reinforcement insert.

8. The method as claimed in claim 1, wherein deploying the reinforcement insert comprises:
providing the reinforcement insert in a retracted condition when inserting it into the free end of the flexible pipe and positioning it at a location along the length of the flexible pipe body; and
once the reinforcement insert is positioned at the desired location, configure the reinforcement insert into a deployed condition by actuating the reinforcement insert so as to radially displace one or more bracing members towards the radially inner surface of the flexible pipe body.

9. The method as claimed in claim 8, wherein moving the reinforcement insert to the deployed condition comprises actuating the reinforcement insert to thereby increase an outer diameter thereof.

10. The method of claim 8, wherein subsequent to configuring the reinforcement insert into the deployed condition retrieving the reinforcement insert, wherein retrieving the reinforcement insert comprises configuring the reinforcement insert into the retracted condition by actuating the reinforcement insert so as to radially displace one or more bracing members away from the radially inner surface of the flexible pipe body.

11. The method as claimed in claim 1, wherein deploying the reinforcement insert comprises:
positioning a first reinforcement insert portion at a location along the length of the flexible pipe body;
positioning at least one further reinforcement insert portion at a location along the length of the flexible pipe body; and
engaging the first and at least one further reinforcement insert portion(s) such that they together oppose radially inwards collapse of at least one layer of the flexible pipe body due to the clamping force.

12. The method of claim 11, wherein engaging the first and at least one further reinforcement insert portion(s) comprises inserting a male segment of one of the portions into a female segment of another of the portions.

13. The method of claim 11, wherein each of the first and at least one further reinforcement insert portion(s) comprise a part-cylindrical outer bracing surface.

14. The method of claim 11, wherein retrieving the reinforcement insert comprises:
disengaging the first and at least one further reinforcement insert portion(s) so as to disassemble the reinforcement insert;
retrieving one of the first and at least one further reinforcement insert portion(s) from the bore of the flexible pipe body;
subsequently retrieving the other insert portion(s) from the bore of the flexible pipe body.

15. The method of claim 1, wherein the deploying the reinforcement insert comprises positioning the reinforcement insert a distance of between 1 metre and 40 metres from the free end of the flexible pipe body.

16. The method of claim 1, wherein the flexible pipe body comprises an end segment of a tubing string.

17. A reinforcement insert for increasing the collapse resistance of a region of a flexible pipe, the reinforcement insert comprising:
one or more radially displaceable bracing members configured to be displaced toward a radially inner surface of a flexible pipe body, in use;
an actuation mechanism arranged to configure the reinforcement insert between a retracted condition and a deployed condition by radial displacement of the bracing member(s);
wherein when configuring the reinforcement insert from the retracted condition to the deployed condition the one or more bracing members are displaced radially outwards so as to increase at least one external dimension of the reinforcement insert.

18. The reinforcement insert of claim 17, wherein in the retracted condition the insert has a first outer diameter and in the deployed condition the insert has a second outer diameter, wherein the second outer diameter is greater than the first outer diameter.

19. The reinforcement insert of claim 17, comprising:
an axial drive member having one or more abutment surfaces configured to contact a corresponding respective abutment surface of each bracing member;
wherein the actuator mechanism is arranged to configure the reinforcement insert from the retracted condition to the deployed condition by displacing the axial drive member towards the bracing member(s) to bring the abutment surfaces into contact and thereby displace the bracing member(s) radially outwards.

20. The reinforcement insert of claim 17, comprising:
a pair of opposed axial drive members each having one or more abutment surfaces configured to contact a corresponding respective abutment surface of each bracing members;
wherein the actuator mechanism is arranged to configure the reinforcement insert from the retracted condition to the deployed condition by displacing the axial drive members towards one another to bring the abutment surface(s) of the axial drive members into contact with the abutment surface(s) of the bracing member(s) and thereby displace the bracing member(s) radially outwards.
